(19) United States
(12) Patent Application Publication
(10) Pub. No.: US 2007/0135082 A1
(43) Pub. Date: Jun. 14, 2007

(54) Dynamic content stream delivery to a telecommunications terminal based on the state of the terminal's battery

(75) Inventors: George William Erhart, Loveland, CO (US); Valentine C. Matula, Granville, OH (US); David Joseph Skiba, Golden, CO (US)

Correspondence Address: DEMONT & BREYER, LLC, 100 COMMONS WAY, STE 250, HOLMDEL, NJ, 07733, US

(73) Assignee: Avaya Technology LLC, Basking Ridge, NJ (US)

(21) Appl. No.: 11/297,092

(22) Filed: Dec. 8, 2005

(51) Int. Cl. H04B 1/16

(52) U.S. Cl. 455/343.5

(57) ABSTRACT

A method and apparatus are disclosed for delivering a content stream to a terminal only if: (i) the terminal has a transducer (e.g., speaker, video display, etc.) that is capable of outputting the content stream's media type, and (ii) the battery of the terminal has sufficient energy to handle receiving, storing, processing, and outputting the content stream. In accordance with the illustrative embodiment, a telecommunications terminal periodically transmits a message that indicates the energy level of its battery, or the media types (e.g., audio, video, etc.) that are welcome at the terminal, or both. The illustrative embodiment is disclosed in the context of an interactive voice response system, but is applicable in a wide variety of other telecommunications systems and applications.

### FIELD OF THE INVENTION

The present invention relates to telecommunications in general, and, more particularly, to the delivery of one or more content streams to a telecommunications terminal based on the state of the terminal's battery.

### BACKGROUND OF THE INVENTION

Many enterprises employ an interactive voice response (IVR) system that handles calls from telecommunications terminals. An interactive voice response system typically presents a hierarchy of menus to the caller, and prompts the caller for input to navigate the menus and to supply information to the IVR system. For example, a caller might touch the “3” key of his terminal's keypad, or say the word “three”, to choose the third option in a menu. Similarly, a caller might specify his bank account number to the interactive voice response system by inputting the digits via the keypad, or by saying the digits. In many interactive voice response systems the caller can connect to a person in the enterprise by either selecting an appropriate menu option, or by entering the telephone extension associated with that person.

FIG. 1 depicts telecommunications system 100 in accordance with the prior art. Telecommunications system 100 comprises telecommunications terminal 101, telecommunications network 105, private branch exchange (PBX) 110, and interactive voice response system 120, interconnected as shown.

Telecommunications terminal 101 is one of a telephone, a notebook computer, a personal digital assistant (PDA), etc. and is capable of placing and receiving calls via telecommunications network 105.

Telecommunications network 105 is a network such as the Public Switched Telephone Network [PSTN], the Internet, etc. that carries calls to and from telecommunications terminal 101, private branch exchange 110, and other devices not show in FIG. 1. A call might be a conventional voice telephony call, a text-based instant messaging (IM) session, a Voice over Internet Protocol (VOIP) call, etc.

Private branch exchange (PBX) 110 receives incoming calls from telecommunications network 105 and directs the calls to interactive voice response (IVR) system 120 or to one of a plurality of telecommunications terminals within the enterprise, depending on how private branch exchange 110 is programmed or configured. For example, in an enterprise call center, private branch exchange 110 might comprise logic for routing calls to service agents' terminals based on criteria such as how busy various service agents have been in a recent time interval, the telephone number called, and so forth. In addition, private branch exchange 110 might be programmed or configured so that an incoming call is initially routed to interactive voice response (IVR) system 120, and, based on caller input to IVR system 120, subsequently redirected back to PBX 110 for routing to an appropriate telecommunications terminal within the enterprise. Private branch exchange (PBX) 110 also receives outbound signals from telecommunications terminals within the enterprise and from interactive voice response (IVR) system 120, and transmits the signals on to telecommunications network 105 for delivery to a caller's terminal.

Interactive voice response (IVR) system 120 is a data-processing system that presents one or more menus to a caller and receives caller input (e.g., speech signals, keypad input, etc.), as described above, via private branch exchange 110. Interactive voice response system (IVR) 120 is typically programmable and performs its tasks by executing one or more instances of an IVR system application. An IVR system application typically comprises one or more scripts that specify what speech is generated by interactive voice response system 120, what input to collect from the caller, and what actions to take in response to caller input. For example, an IVR system application might comprise a top-level script that presents a main menu to the caller, and additional scripts that correspond to each of the menu options (e.g., a script for reviewing bank account balances, a script for making a transfer of funds between accounts, etc.).

A popular language for such scripts is the Voice eXtensible Markup Language (abbreviated VoiceXML or VXML). The Voice extensible Markup Language is an application of the extensible Markup Language, abbreviated XML, which enables the creation of customized tags for defining, transmitting, validating, and interpretation of data between two applications, organizations, etc. The Voice extensible Markup Language enables dialogs that feature synthesized speech, digitized audio, recognition of spoken and keyed input, recording of spoken input, and telephony. A primary objective of VXML is to bring the advantages of web-based development and content delivery to interactive voice response system applications.

FIG. 2 depicts an exemplary Voice eXtensible Markup Language (VXML) script (also known as a VXML document or page), in accordance with the prior art. The VXML script, when executed by interactive voice response system 120, presents a menu with three options; the first option is for transferring the call to the sales department, the second option is for transferring the call to the marketing department, and the third option is for transferring the call to the customer support department. Audio content (in particular, synthesized speech) that corresponds to text between the <prompt> and </prompt> tags is generated by interactive voice response system 120 and transmitted to the caller.

### SUMMARY OF THE INVENTION

As video displays become ubiquitous in telecommunications terminals, it can be advantageous to deliver video content to a telecommunications terminal during a call with an interactive voice response (IVR) system, in addition to audio content. For example, a user of a telecommunications terminal who is ordering apparel via an IVR system might receive a video content stream related to a particular item (e.g., depicting a model who is wearing the item, depicting the different available colors for the item, etc.). Furthermore, in some instances it might be desirable to deliver an audio content stream (e.g., music, news, etc.) to the user, perhaps during silent periods in the call, or perhaps as background audio throughout the entire call.

The illustrative embodiment of the present invention enables an IVR system to deliver content streams of various media types (e.g., video, audio, etc.) to telecommunications terminals via the addition of extensions to the Voice extensible Markup Language (VXML) standard. Furthermore, in accordance with the illustrative embodiment, an interactive voice response (IVR) system will deliver a particular content stream to a terminal only if: (i) the terminal has a transducer (e.g., speaker, video display, etc.) that is capable of outputting the content stream's media type, and (ii) the battery of the terminal has sufficient energy to receive, store, process, and output the content stream. For example, although a terminal might have both a speaker and a video display, the terminal's battery might be depleted to such an extent that the terminal is able to handle an incoming audio stream, but not a video stream. As another example, although a terminal might have a video display, the terminal's battery might be depleted so that the terminal can only handle video streams that are less than two minutes in length.

In accordance with the illustrative embodiment, a telecommunications terminal notifies the interactive voice response system of the energy level of the terminal's battery at the beginning of a call, and optionally, updates this information during the call. If a script of the interactive voice response system contains a command to deliver a content stream to the telecommunications terminal, and the terminal's battery does not have sufficient energy to handle the content stream, the interactive voice response system will not deliver the content stream. Similarly, if an IVR system script contains a command to deliver a group of two or more content streams, the interactive voice response system will deliver only those streams in the group, if any, that the terminal's battery can handle.

In accordance with the illustrative embodiment, if, while a content stream is being delivered to a terminal, the interactive voice response system receives a signal that indicates that the energy level of the terminal's battery has fallen below a particular threshold, then the interactive voice response system stops transmitting the content stream. Furthermore, if the terminal is subsequently connected to a supplementary power source (e.g., an AC outlet, etc.) during the call after the stopping of a content stream, then the interactive voice response system either (i) resumes transmission of the stopped content stream (i.e., begins transmitting the stream at the point at which playback was stopped) or (ii) re-starts transmission of the stopped content stream from the beginning. Whether a stopped content stream is resumed or re-started can be based on factors such as: an implementation choice, a system administrator's preferences, a caller's preferences, the nature of a particular content stream (e.g., real-time versus pre-recorded, etc.), and so forth.

In accordance with the illustrative embodiment, a telecommunications terminal might also notify the interactive voice response system that a particular media type is not welcome at the terminal due to the energy level of the terminal's battery. This notification can be transmitted at the beginning of a call, or during a call, or both. In addition, the notification might be sent as a separate message, or might be included in a message that contains other information (e.g., the energy level of the terminal's battery, etc.).

The illustrative embodiment comprises: transmitting a signal to a telecommunications terminal only when the energy level of said telecommunications terminal's battery is above a threshold.

### BRIEF DESCRIPTION OF THE DRAWINGS

FIG. 1 depicts telecommunications system 100 in accordance with the prior art.

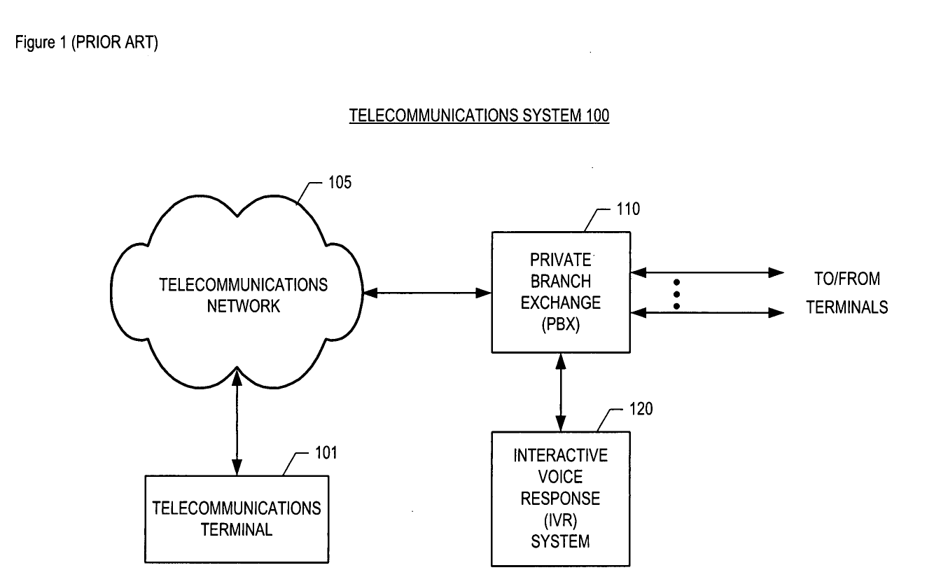

FIG. 2 depicts an exemplary Voice extensible Markup Language (VXML) script, in accordance with the prior art.

FIG. 3 depicts telecommunications system 300 in accordance with the illustrative embodiment of the present invention.

FIG. 4 depicts an exemplary Voice extensible Markup Language (VXML) script, in accordance with the illustrative embodiment of the present invention.

FIG. 5 depicts a flowchart of the salient tasks of interactive voice response system 320, as shown in FIG. 3, in accordance with the illustrative embodiment of the present invention.

FIG. 6 depicts a flowchart of the salient tasks of a thread that is spawned at task 560 of FIG. 5, in accordance with the illustrative embodiment of the present invention.

FIG. 7 depicts a detailed flowchart of task 630, as shown in FIG. 6, in accordance with the illustrative embodiment of the present invention.

FIG. 8 depicts a detailed flowchart of task 650, as shown in FIG. 6, in accordance with the illustrative embodiment of the present invention.

FIG. 9 depicts a detailed flowchart of task 660, as shown in FIG. 6, in accordance with the illustrative embodiment of the present invention.

FIG. 10 depicts a flowchart of the salient tasks of telecommunications terminal 301, as shown in FIG. 3, during a call with interactive voice response system 320, in accordance with the illustrative embodiment of the present invention.

### DETAILED DESCRIPTION

The terms appearing below are given the following definitions for use in this Description and the appended Claims.

For the purposes of the specification and claims, the term “call” is defined as an interactive communication involving one or more telecommunications terminal users. A call might be a traditional voice telephone call, an instant messaging (IM) session, a video conference, etc.

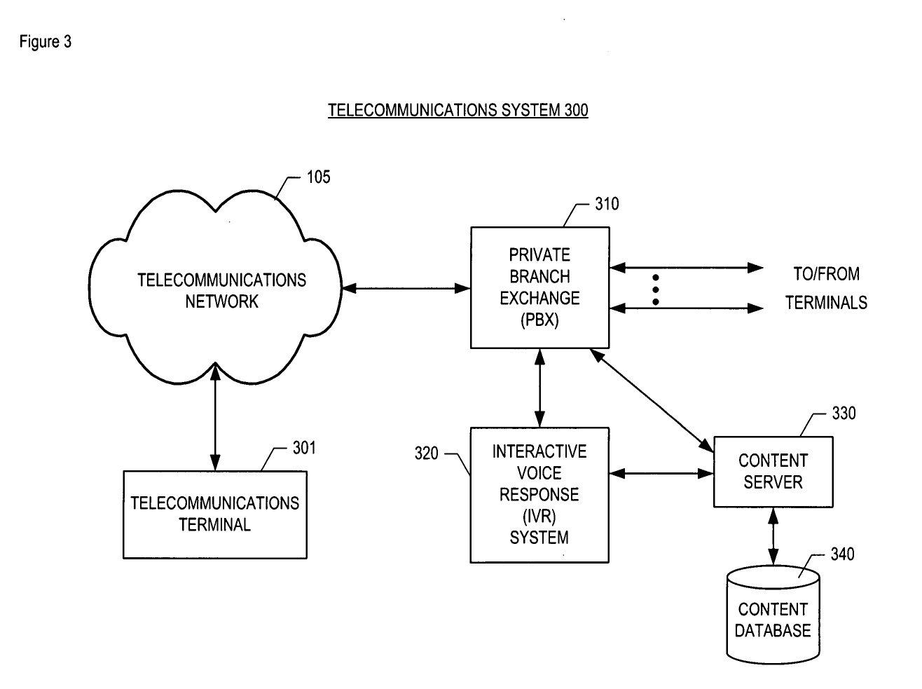

FIG. 3 depicts telecommunications system 300 in accordance with the illustrative embodiment of the present invention. Telecommunications system 300 comprises telecommunications terminal 301, telecommunications network 105, private branch exchange (PBX) 310, interactive voice response system 320, content server 330, and content database 340, interconnected as shown.

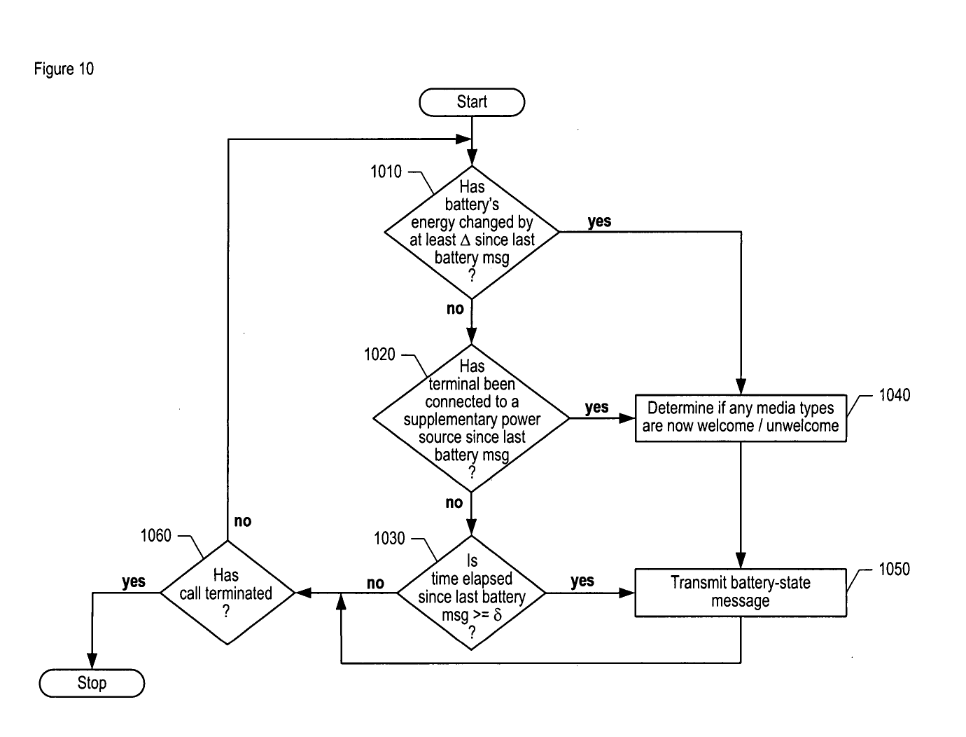

Telecommunications terminal 301 is one of a telephone, a notebook computer, a personal digital assistant (PDA), etc. and is capable of placing and receiving calls via telecommunications network 305. Telecommunications terminal 301 also has one or more transducers (e.g., a speaker, a video display, etc.) for outputting signals that are received via telecommunications network 105, in well-known fashion. In addition, telecommunications terminal 301 is capable of performing the tasks of FIG. 10, described below.

Private branch exchange (PBX) 310 provides all the functionality of private branch exchange (PBX) 110 of the prior art, and is also capable of receiving streamed content (e.g., audio, video, multimedia, etc.) from content server 330, of forwarding streamed content on to telecommunications network 105 for delivery to a caller's terminal, and of transmitting signals related to streamed content to content server 330. Furthermore, in addition to conventional telephony-based signaling and voice signals, private branch exchange 310 is also capable of transmitting and receiving Internet Protocol (IP) data packets, Session Initiation Protocol (SIP) messages, Voice over IP (VOIP) traffic, and stream-related messages (e.g., Real Time Streaming Protocol [RTSP] messages, etc.) to and from IVR system 320. It will be clear to those skilled in the art, after reading this specification, how to make and use private branch exchange (PBX) 310.

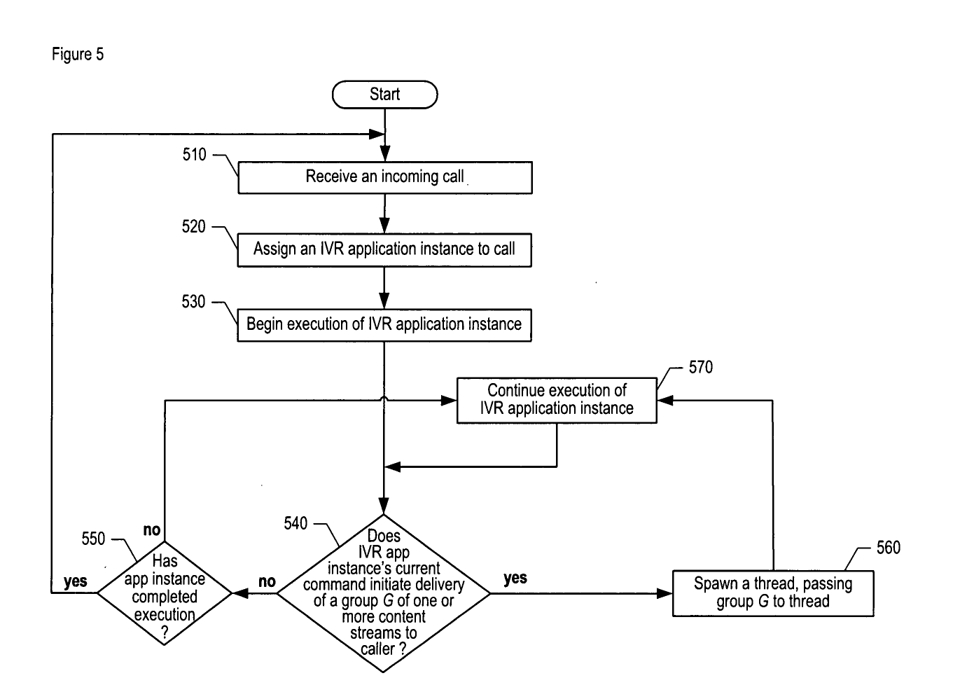

Interactive voice response system 320 provides all the functionality of interactive voice response system 120 of the prior art, and is also capable of transmitting commands to content server 330 (e.g., starting playback of a content stream, stopping playback of the content stream, queueing another content stream, etc.) and of receiving information from content server 330 (e.g., an indication that playback of a content stream has begun, an indication that playback of a content stream has completed, etc.). In addition, interactive voice response system 320 is capable of performing the tasks of FIGS. 5 through 9, described below. It will be clear to those skilled in the art, after reading this specification, how to make and use interactive voice response system 320.

Content server 330 is capable of retrieving content from content database 340, of buffering and delivering a content stream to a calling terminal via private branch exchange 310, of receiving commands from interactive voice response system 320 (e.g., to start playback of a content stream, to queue another content stream, etc.), of transmitting status information to interactive voice response system 320, and of generating content (e.g., dynamically generating a video of rendered text, etc.) in well-known fashion. It will be clear to those skilled in the art, after reading this specification, how to make and use content server 330.

Content database 340 is capable of storing a plurality of multimedia content (e.g., video content, audio content, etc.) and of retrieving content in response to commands from content server 330, in well-known fashion. It will be clear to those skilled in the art, after reading this specification, how to make and use content database 340.

As will be appreciated by those skilled in the art, some embodiments of the present invention might employ an architecture for telecommunications system 300 that is different than that of the illustrative embodiment (e.g., interactive voice response system 320 and content server 330 might reside on a common server, etc.). It will be clear to those skilled in the art, after reading this specification, how to make and use such alternative architectures.

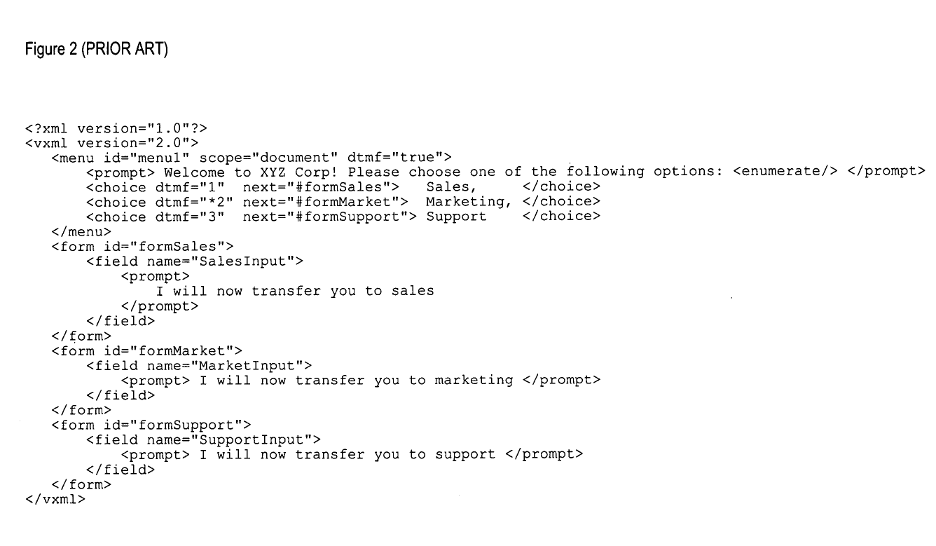

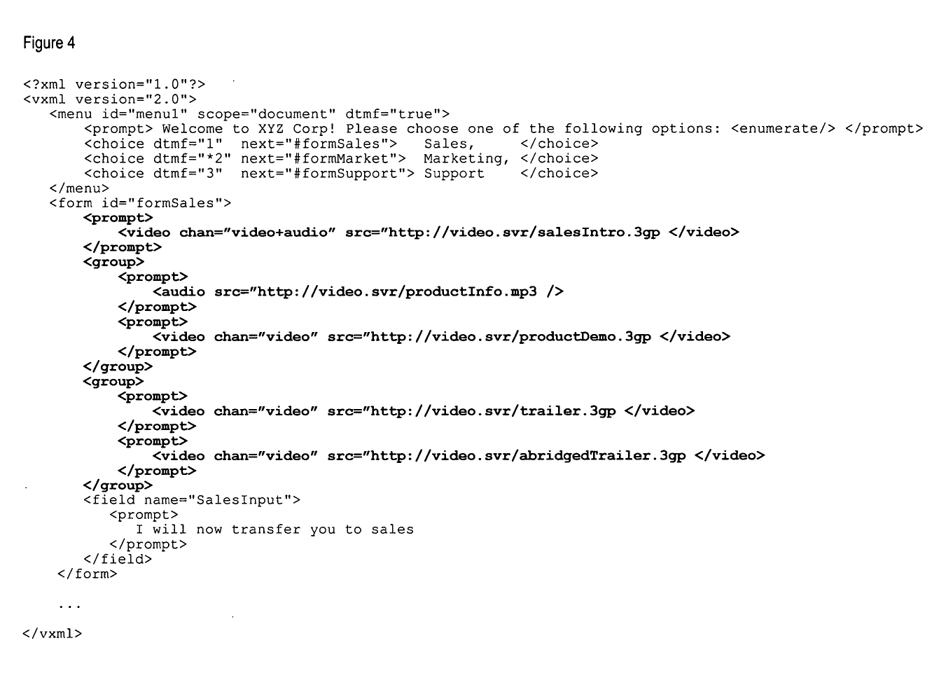

FIG. 4 depicts an exemplary Voice Extensible Markup Language (VXML) script, in accordance with the illustrative embodiment of the present invention. The script is the same as the script of FIG. 2 of the prior art, with the addition of lines of code depicted in boldface. As shown in FIG. 4, the script now contains prompts that are audio and video content streams, in addition to speech prompts.

In accordance with the script of FIG. 4 of the illustrative embodiment, when a user selects choice 1 (sales), interactive voice response system 320 delivers one, both, or neither of the audio and video portions of stream salesIntro.3gp in accordance with Table 1:

TABLE 1
Delivery of Audio and Video Based on Terminal's Battery

| Terminal | Terminal | Battery | Battery | IVR | IVR |
|---|---|---|---|---|---|
| has | has | can handle | can handle | delivers | delivers |
| speaker | display | audio | video | audio | video |
| ✓ | ✓ | ✓ | ✓ | ✓ | ✓ |
| ✓ | | ✓ | ✓ | ✓ | |
| | ✓ | ✓ | ✓ | | ✓ |
| ✓ | ✓ | ✓ | | ✓ | |
| | ✓ | ✓ | | | |
| ✓ | ✓ | | | | |

For example, the second row of Table 1 indicates that if the terminal's battery only has enough energy to handle the audio stream portion of salesIntro.3gp, then interactive voice response system 320 will deliver only the audio stream portion of salesIntro.3gp.

Note that some unnecessary combinations have been excluded from Table 1 (e.g., battery cannot handle video and terminal does not have a video display, etc.). In addition, because audio typically consumes significantly less power than video, it is assumed in Table 1 that if the terminal's battery is able to handle the video stream, then the battery can also handle the audio stream. As will be appreciated by those skilled in the art, in some embodiments Table 1 might be expanded to include additional entries when other combinations do make sense. For example, there might be particular media types T₁ and T₂ such that a terminal's battery could handle either of (i) a content stream of type T₁, and (ii) a content stream of type T₂, but not both.

Furthermore, note that Table 1 is a simplification of the operation of interactive voice response system 320 in accordance with the illustrative embodiment. In particular, other factors that can affect the behavior of interactive voice response system 320, such as the length of a particular content stream, are not addressed in Table 1, but are described below and with respect to FIGS. 5 through 9. In addition, the particular tasks that are performed by interactive voice response system 320 in order to process scripts in accordance with Table 1, or in accordance with some other table or policy, are also described below and with respect to FIGS. 5 through 9.

As shown in FIG. 4, in accordance with the illustrative embodiment, a VXML script can also have a <group> block that comprises a plurality of content streams. The script of FIG. 4 has a first <group> block that comprises an audio content stream productInfo.mp3 and a video content stream productDemo.3gp, and a second <group>block that comprises two video content streams, trailer.3gp and abridgedTrailer.3gp.

In accordance with the illustrative embodiment, the content streams in a <group> block can be either: (i) all of the same media type, or (ii) all of different media types (i.e., no two streams have the same media type). When a <group> block contains content streams of all different media types, interactive voice response system 320 will deliver concurrently as many of the streams as the calling terminal's battery is capable of receiving, storing, processing, and outputting. For example, in the first <group> block of the script of FIG. 4, interactive voice response system 320 will deliver one, both, or neither of audio content stream productInfo.mp3 and video content stream productDemo.3gp in accordance with Table 1 above. The particular tasks that are performed by interactive voice response system 320 in order to process a <group> block in this manner are described below and with respect to FIGS. 5 through 9.

In accordance with the illustrative embodiment, when a <group> block contains content streams of the same media type, interactive voice response system 320 will deliver one of the content streams, and in particular, the most power-consuming content stream that the calling terminal's battery is capable of handling (i.e., receiving, storing, processing, and outputting). For example, in the second <group> block of the script of FIG. 4, interactive voice response system 320 will deliver:
video stream trailer.3gp if the calling terminal's battery can handle it;
video stream abridgedTrailer.3gp if the calling terminal's battery cannot handle trailer.3gp but can handle abridgedTrailer.3gp; or
neither trailer.3gp nor abridgedTrailer.3gp if the calling terminal's battery cannot handle either stream.
   The particular tasks that are performed by interactive voice response system 320 in order to process a <group> block in this manner are described below and with respect to FIGS. 5 through 9.

As will be appreciated by those skilled in the art, in some other embodiments of the present invention, a tag or programming language construct other than a <group> block might be employed to organize multiple content streams.

In the script of FIG. 4, the second <group> block is followed by a single video-only prompt disclaimer.3gp. Interactive voice response system 320 will deliver video content stream disclaimer.3gp only if the calling terminal's battery has sufficient energy to handle this video content stream. The particular tasks that are performed by interactive voice response system 320 in order to process prompts in this manner are described below and with respect to FIGS. 5 through 9.

FIG. 5 depicts a flowchart of the salient tasks of interactive voice response system 320, in accordance with the illustrative embodiment of the present invention. It will be clear to those skilled in the art which tasks depicted in FIG. 5 can be performed simultaneously or in a different order than that depicted.

At task 510, an incoming call is received at interactive voice response system 320, in well-known fashion.

At task 520, interactive voice response system 320 assigns an instance of an appropriate IVR system application to the incoming call, in well-known fashion. As will be appreciated by those skilled in the art, although in the illustrative embodiment an instance of an IVR system application handles one incoming call at a time, in some other embodiments of the present invention an application instance might handle a plurality of calls concurrently.

At task 530, interactive voice response system 320 begins executing the IVR application instance, in well-known fashion.

At task 540, interactive voice response system 320 checks whether the current command to be executed in the IVR application instance initiates delivery of a group G of one or more content streams to the calling telecommunications terminal. A group that comprises multiple content streams might be specified explicitly by a <group> block, or implicitly via a single prompt (e.g., the audio and video streams of a 3gp file, etc.), while a group that comprises a single content stream will typically be specified by a single prompt (e.g., an audio prompt, a video prompt in which chan=“video”, etc.). If the current command initiates delivery of a group G of one or more content streams, execution continues at task 560, otherwise, execution proceeds to task 550.

At task 550, interactive voice response system 320 checks whether the IVR application instance's execution has completed. If so, execution continues back at task 510 for the next incoming call; otherwise, execution proceeds to task 590.

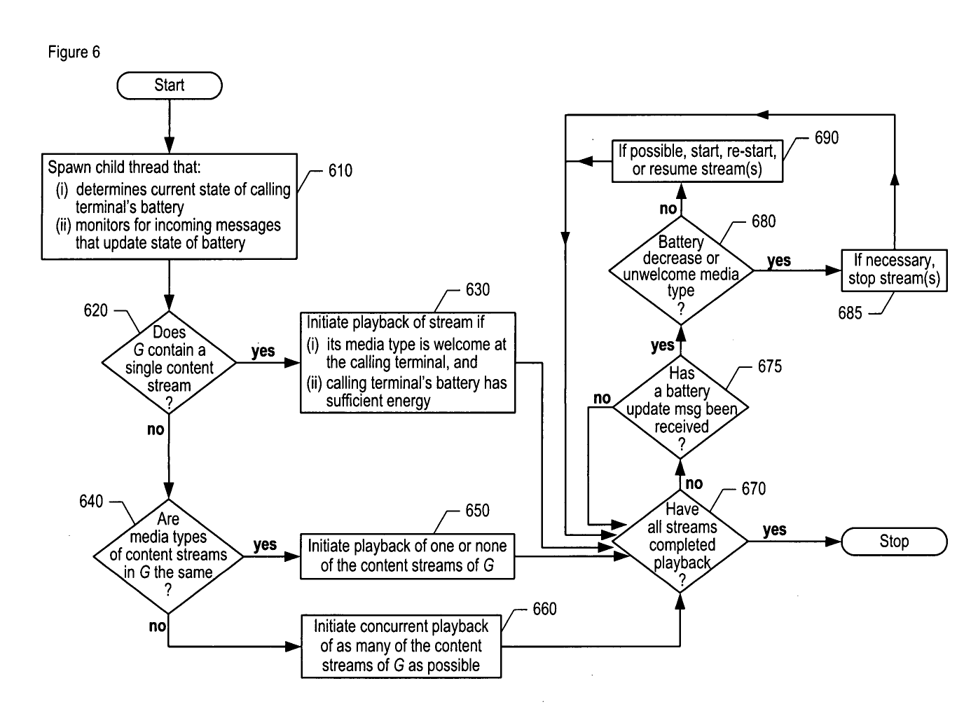

At task 560, interactive voice response system 320 spawns a thread that is responsible for starting and stopping the delivery of content streams to the calling terminal during the call. Group G is passed to the thread, in well-known fashion (e.g., via a memory pointer, via an operating system inter-thread communication mechanism, etc.). The operation of this thread is described in detail below and with respect to FIGS. 6 through 9.

At task 570, interactive voice response system 320 continues the execution of the IVR application instance, in well-known fashion. After task 570, execution continues back at task 540.

FIG. 6 depicts a flowchart of the salient tasks of the thread spawned at task 560, in accordance with the illustrative embodiment of the present invention. It will be clear to those skilled in the art which tasks depicted in FIG. 6 can be performed simultaneously or in a different order than that depicted.

At task 610, the thread spawns a child thread that: (i) determines the current state of the calling terminal's battery and (ii) monitors during the call for incoming messages that update the state of the calling terminal's battery. In accordance with the illustrative embodiment, the battery's state comprises one or more of the following: the battery's energy level; whether the battery's energy level is above or below one or more thresholds; what media types, if any, are unwelcome at the calling terminal; and so forth. The child thread performs subtask (i) once at startup, and performs subtask (ii) continually during the call. The child thread dies when the (parent) thread dies (i.e., after the determination of task 670, described below, is affirmative).

At task 620, the thread checks whether group G contains a single content stream S. If so, execution proceeds to task 630, otherwise execution continues at task 640.

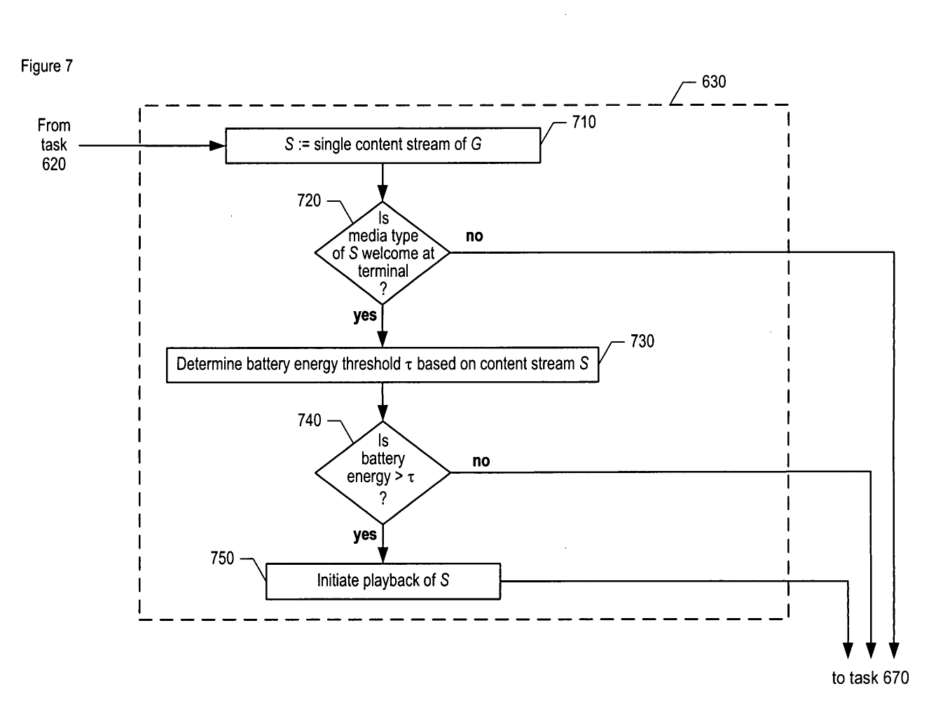

At task 630, the thread initiates playback of the single content stream S if both: (i) its media type is welcome at the calling terminal, and (ii) the calling terminal's battery has sufficient energy. Task 630 is described in detail below and with respect to FIG. 7.

At task 640, the thread checks whether all the content streams of group G have the same media type. If so, execution proceeds to task 650, otherwise execution continues at task 660.

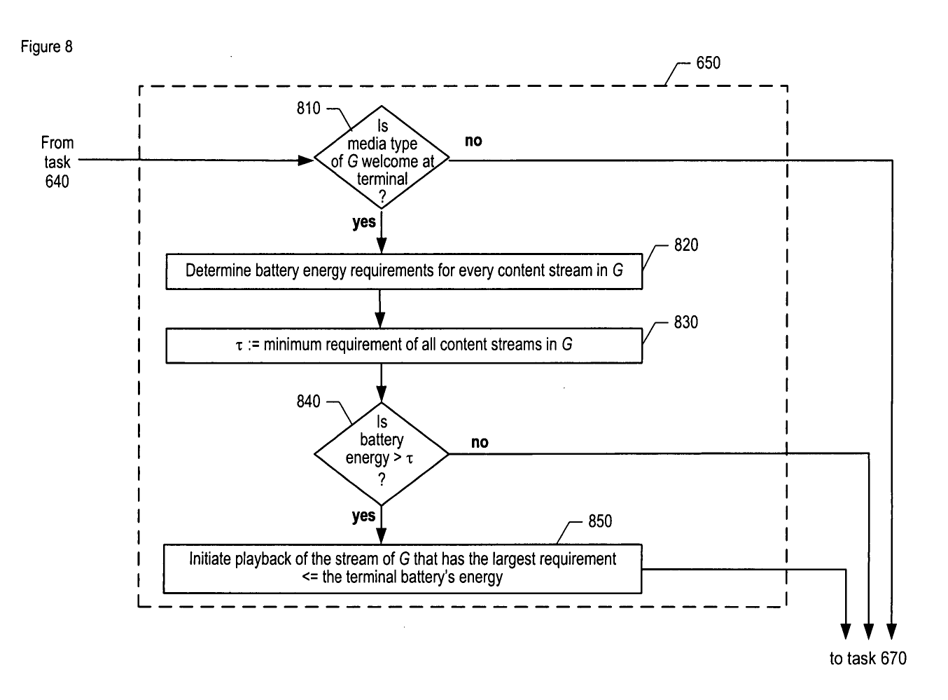

At task 650, the thread initiates playback of either (i) one of the content streams of group G, or (ii) none of the content streams of group G, as described in detail below and with respect to FIG. 8.

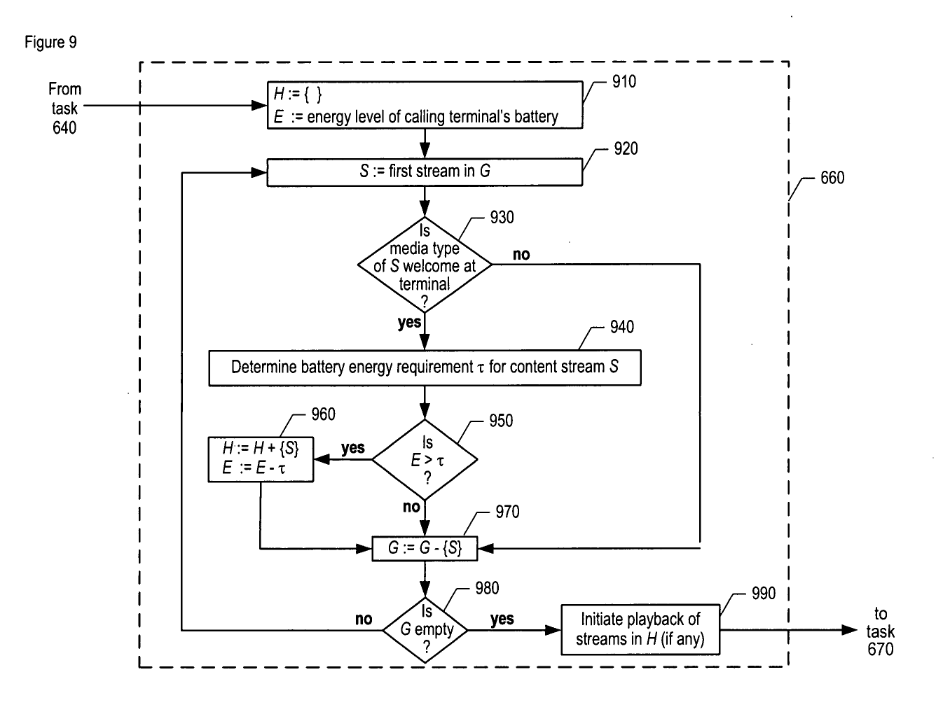

At task 660, the thread initiates concurrent playback of as many of the content streams of group G as possible, as described in detail below and with respect to FIG. 9.

At task 670, the thread checks whether playback of all content streams has completed. If so, the thread and its child (spawned at task 610 ) die, otherwise execution continues at task 675.

At task 675, the thread checks whether a message that updates the status of the calling terminal's battery has been received. If not, execution continues back at task 670, otherwise execution proceeds to task 680.

At task 680, the thread checks whether the message indicates that one or both of: (i) the energy level of the calling terminal's battery has decreased, and (ii) a particular media type is now unwelcome at the calling terminal. If so, execution proceeds to task 685, otherwise execution continues at task 690.

At task 685, the thread stops, if necessary, one or more of the content streams that are being delivered to the calling terminal, based on the contents of the message. After task 685, execution of the thread continues back at task 670.

At task 690, the thread, if possible, starts playback of one or more new content streams, or resumes/re-starts playback of one or more stopped content streams, or both, as a result of:

(i) an increased (or possibly unchanged) battery energy level, or

(ii) an indication that a particular media type is now welcome at the calling terminal, or

(iii) both (i) and (ii).

After task 690, execution of the thread continues back at task 670.

FIG. 7 depicts a detailed flowchart of task 630, in accordance with the illustrative embodiment of the present invention. It will be clear to those skilled in the art which subtasks depicted in FIG. 7 can be performed simultaneously or in a different order than that depicted.

At subtask 710, the thread initializes variable S to the single content stream of group G.

At subtask 720, the thread checks whether the media type of content stream S is welcome at the calling terminal. If so, execution continues at subtask 730, otherwise execution continues at task 670 of FIG. 6.

At subtask 730, the thread determines what battery energy threshold τ is necessary to handle content stream S. In the illustrative embodiment, threshold τ is based on one or more estimates of the energy required to receive, store, process, and output content stream S (e.g., due to the media type of content stream S, the length of content stream S, etc.). As will be appreciated by those skilled in the art, in some other embodiments of the present invention, threshold τ might be based on other factors in addition to, or in lieu of, such estimates.

At subtask 740, the thread checks whether the calling terminal's battery energy level exceeds threshold τ. If so, execution continues at subtask 750, otherwise execution continues at task 670 of FIG. 6.

At subtask 750, the thread initiates playback of content stream S, in well-known fashion. After subtask 750, execution continues at task 670 of FIG. 6.

FIG. 8 depicts a detailed flowchart of task 650, in accordance with the illustrative embodiment of the present invention. It will be clear to those skilled in the art which subtasks depicted in FIG. 8 can be performed simultaneously or in a different order than that depicted.

At subtask 810, the thread checks whether the media type of group G is welcome at the calling terminal. If so, execution continues at subtask 820, otherwise execution continues at task 670 of FIG. 6.

At subtask 820, the thread determines the battery energy requirements for each content stream of group G. As described above, in the illustrative embodiment this determination is based on one or more estimates of the energy required to receive, store, process, and output each of the content streams of group G.

At subtask 830, the thread sets the value of threshold τ to the minimum of the battery energy requirements determined at subtask 820.

At subtask 840, the thread checks whether the calling terminal's battery energy exceeds threshold τ. If so, execution continues at subtask 850, otherwise execution continues at task 670 of FIG. 6.

At subtask 850, the thread initiates playback of the content stream S of group G that has the largest battery energy requirement that is less than the calling terminal's battery energy. After subtask 750, execution continues at task 670 of FIG. 6.

FIG. 9 depicts a detailed flowchart of task 660, in accordance with the illustrative embodiment of the present invention. It will be clear to those skilled in the art which subtasks depicted in FIG. 9 can be performed simultaneously or in a different order than that depicted.

At subtask 910, the thread initializes variable H to the empty set, and variable E to the energy level of the calling terminal's battery.

At subtask 920, the thread sets variable S to the first content stream of group G.

At subtask 930, the thread checks whether the media type of content stream S is welcome at the calling terminal. If so, execution continues at subtask 940, otherwise execution continues at subtask 970.

At subtask 940, the thread determines the battery energy requirement threshold τ for content stream S, as described above.

At subtask 950, the thread checks whether E exceeds τ. If so, execution continues at subtask 960, otherwise execution continues at subtask 970.

At subtask 960, the thread adds content stream S to set H, and subtracts τ from q.

At subtask 970, the thread removes content stream S from G.

At subtask 980, the thread checks whether G is empty. If so, execution continues at subtask 990, otherwise execution continues back at subtask 920.

At subtask 990, the thread initiates playback of the content streams in H, if there are any. After subtask 990, execution continues at task 670 of FIG. 6.

As will be appreciated by those skilled in the art, the method of FIG. 9 is a greedy heuristic for obtaining a good, but not necessarily optimal, utilization of the available battery energy. The problem of obtaining an optimal utilization is analogous to the NP-complete bin packing problem, and therefore there is no known polynomial-time algorithm for determining an optimal utilization. It might be desirable in some embodiments of the present invention, however, to test all possible stream combinations and determine the optimal combination, particularly when a block has a small number of content streams. Alternatively, when using the greedy heuristic of FIG. 9, it might be desirable in some embodiments of the present invention to enforce a particular ordering of media types in a block (e.g., first stream video, second stream audio, etc.).

FIG. 10 depicts a flowchart of the salient tasks of telecommunications terminal 301 during a call with interactive voice response system 320, in accordance with the illustrative embodiment of the present invention.

At task 1010, telecommunications terminal 301 checks whether its battery's energy has changed by at least Δ since the last battery message that was transmitted by telecommunications terminal 301 (at task 1040, below). If so, execution proceeds to task 1040, otherwise execution continues at task 1020.

As will be appreciated by those skilled in the art, the energy level of terminal 301 's battery typically decreases as a result of normal operation, but might also increase when a battery is in the process of charging. As will further be appreciated by those skilled in the art, a particular value for Δ can be selected based on a variety of factors including the battery's capacity, power requirement estimates for handling various content streams at telecommunications terminal 301, and so forth. Furthermore, in some embodiments of the present invention, Δ might be an absolute quantity, while in some other embodiments Δ might be a relative quantity (e.g., 3% of battery capacity, 5% of remaining battery energy, etc.).

At task 1020, telecommunications terminal 301 checks whether it has been connected to a supplementary power source (e.g., an AC outlet, etc.) since the last battery message was transmitted. If so, execution proceeds to task 1040, otherwise execution continues at task 1030.

At task 1030, telecommunications terminal 301 checks whether at least δ seconds have elapsed since the last battery message that was transmitted by telecommunications terminal 301. If so, execution proceeds to task 1050, otherwise execution continues at task 1060.

At task 1040, telecommunications terminal 301 determines which media types are now unwelcome or newly-welcome as a result of either (i) a change in battery energy, or (ii) connection to a supplementary power source. As described above, in the illustrative embodiment the determination of task 1040 is based on estimates of the energy required to receive, store, process, and output content streams of various media types, lengths, and so forth. As will be appreciated by those skilled in the art, in some other embodiments of the present invention, task 1040 might be based on other factors in addition to, or in lieu of, such estimates.

At task 1050, telecommunications terminal 301 transmits a message to interactive voice response system 320 that indicates the updated state of the terminal's battery (e.g., the battery's energy, what media types are welcome or unwelcome at terminal 301 due to the battery's energy, etc.). In the illustrative embodiment, this message is transmitted in accordance with the Session Initiation Protocol (SIP). It will be clear to those skilled in the art how to send this battery-state information via some other protocol or signal.

At task 1060, telecommunications terminal 301 checks whether the call has terminated. If so, the method of FIG. 10 terminates, otherwise execution continues back at task 1010.

As will be appreciated by those skilled in the art, in some embodiments of the present invention it might be advantageous for telecommunications network 105 to be aware of changes in the state of telecommunications terminal 301 's battery when the terminal is not involved in a call with interactive voice response system 320 (e.g., during a call with another terminal, between calls, etc.) Such embodiments could enable other applications of telecommunications network 105 that are independent of interactive voice response system 320 to make use of this information. As will be appreciated by those skilled in the art, in such embodiments the method of FIG. 10 should be modified so that it executes at times other than just during calls with interactive voice response system 320. As will be further appreciated by those skilled in the art, in such embodiments one or more terminals or elements of telecommunications network 105 's infrastructure (e.g., a switch, etc.) might be reprogrammed to monitor and receive messages that are transmitted by terminal 301 in accordance with the method of FIG. 10, as is done by the child thread spawned at task 610 at interactive voice response system 320.

It is to be understood that the above-described embodiments are merely illustrative of the present invention and that many variations of the above-described embodiments can be devised by those skilled in the art without departing from the scope of the invention. For example, in this Specification, numerous specific details are provided in order to provide a thorough description and understanding of the illustrative embodiments of the present invention. Those skilled in the art will recognize, however, that the invention can be practiced without one or more of those details, or with other methods, materials, components, etc.

Furthermore, in some instances, well-known structures, materials, or operations are not shown or described in detail to avoid obscuring aspects of the illustrative embodiments. It is understood that the various embodiments shown in the Figures are illustrative, and are not necessarily drawn to scale. Reference throughout the specification to “one embodiment” or “an embodiment” or “some embodiments” means that a particular feature, structure, material, or characteristic described in connection with the embodiment(s) is included in at least one embodiment of the present invention, but not necessarily all embodiments. Consequently, the appearances of the phrase “in one embodiment,” “in an embodiment,” or “in some embodiments” in various places throughout the Specification are not necessarily all referring to the same embodiment. Furthermore, the particular features, structures, materials, or characteristics can be combined in any suitable manner in one or more embodiments. It is therefore intended that such variations be included within the scope of the following claims and their equivalents.

What is claimed is:

1. A method comprising transmitting a signal to a telecommunications terminal only when the energy level of said telecommunications terminal's battery is above a threshold.

2. The method of claim 1 wherein the transmitting is during a call that involves said telecommunications terminal.

3. The method of claim 2 wherein said threshold is based on the media type of said signal.

4. The method of claim 2 wherein said threshold is based on an estimate of the power required to receive, store, process, and output said signal.

5. A method comprising stopping the transmission of a first signal to a telecommunications terminal during a call that involves said telecommunications terminal when the energy level of said telecommunications terminal's battery falls below a threshold.

6. The method of claim 5 further comprising:
resuming the transmission of said first signal when the energy level of said telecommunications terminal's battery rises above said threshold.

7. The method of claim 5 further comprising:
transmitting a second signal to said telecommunications terminal in lieu of said first signal when the energy level of said telecommunications terminal's battery rises above said threshold.

8. The method of claim 5 further comprising:
re-starting the transmission of said first signal when said telecommunications terminal is connected to a supplementary power source.

9. The method of claim 5 further comprising:
transmitting a second signal to said telecommunications terminal in lieu of said first signal when said telecommunications terminal is connected to a supplementary power source.

10. A method comprising transmitting to a telecommunications terminal exactly one of a first signal and a second signal, wherein the signal that is transmitted is based on the energy level of said telecommunications terminal's battery.

11. The method of claim 10 wherein said first signal and said second signal are of different media types.

12. The method of claim 10 wherein the power required to receive, store, process, and output said first signal is different than the power required to receive, store, process, and output said second signal.

13. The method of claim 12 wherein said first signal and said second signal are of the same media type.

14. A method comprising:
transmitting to a telecommunications terminal a first signal of media type T₁ and a second signal of media type T₂; and
when the energy level of said telecommunications terminal's battery falls below a threshold, stopping the transmission of said first signal only.

15. The method of claim 21 wherein the transmitting and the stopping is during a call that involves said telecommunications terminal.

16. A method comprising transmitting a first signal from a telecommunications terminal when the energy level of said telecommunications terminal's battery falls below a threshold, wherein said first signal is for notifying at least one of:
(i) a network infrastructure element,
(ii) another telecommunications terminal, and
(iii) an interactive voice response system that any signal whose media type belongs to a non-empty set S of media types is unwelcome at said telecommunications terminal.

17. The method of claim 16 wherein the energy level of said telecommunications terminal's battery falls below said threshold during a call that involves said telecommunications terminal, and wherein the transmitting of said first signal occurs during said call.

18. The method of claim 16 wherein said telecommunications terminal is receiving a second signal whose media type belongs to said set S when the energy level of said telecommunications terminal's battery falls below said threshold.

19. A method comprising transmitting a first signal from a telecommunications terminal when
(a) the energy level of said telecommunications terminal's battery is below a threshold, and
(b) said telecommunications terminal is connected to a supplementary power source, wherein said first signal is for notifying at least one of:
(i) a network infrastructure element,
(ii) another telecommunications terminal, and
(iii) an interactive voice response system that any signal whose media type belongs to a non-empty set S of media types is now welcome at said telecommunications terminal.

20. The method of claim 19 wherein said telecommunications terminal is connected to a supplementary power source during a call that involves said telecommunications terminal.

21. The method of claim 20 wherein said call also involves said interactive voice response system, and wherein said first signal is also for notifying said interactive voice response system to re-start the transmission of a second signal whose media type belongs to said set S to said telecommunications terminal.

22. The method of claim 20 wherein said call also involves said interactive voice response system, and wherein said first signal is also for notifying said interactive voice response system to resume the transmission of a second signal whose media type belongs to said set S to said telecommunications terminal.

23. A method comprising transmitting a first signal from a telecommunications terminal when the energy level of said telecommunications terminal's battery rises above a threshold, wherein said signal is for notifying at least one of:
(i) a network infrastructure element,
(ii) another telecommunications terminal, and
(iii) an interactive voice response system that any signal whose media type belongs to a non-empty set S of media types is now welcome at said telecommunications terminal.

24. The method of claim 23 further comprising receiving at said telecommunications terminal a second signal whose media type belongs to said set S.
